(19) United States
(12) Patent Application Publication
(10) Pub. No.: US 2008/0288999 A1
(43) Pub. Date: Nov. 20, 2008

(54) INFORMATION PROCESSING APPARATUS FOR AUTHENTICATION SETTING OF MODEL THAT REQUIRES CONFIDENTIALITY

(75) Inventors: Fumiko Satoh, Tokyo (JP); Yuichi Nakamura, Yokohama (JP); Kouichi Ono, Tokyo (JP)

Correspondence Address: PATENT INGENUITY, PC, 520 BROADWAY, SUITE 350, SANTA MONICA, CA, 90401, US

(73) Assignee: INTERNATIONAL BUSINESS MACHINES CORPORATION, Armonk, NY (US)

(21) Appl. No.: 11/689,991

(22) Filed: Mar. 22, 2007

(30) Foreign Application Priority Data
Mar. 22, 2006 (JP) 2006-078568

(51) Int. Cl. G06F 17/00

(52) U.S. Cl. 726/1

(57) ABSTRACT

The present disclosure provides an information processing apparatus and the like, which allow a service developer, who develops a service requiring confidentiality in a service-oriented architecture, to easily create authentication settings for the service model. The present disclosure provides an information processing apparatus for developing a service requiring confidentiality in a service-oriented architecture. The information processing apparatus includes: an input unit for inputting an annotation for a service; a storage unit for storing an Authentication Infrastructure Model of a machine node on which the service is executed; and an Authentication Policy generation unit for generating an Authentication Policy by using the annotation and the Authentication Infrastructure Model.

### RELATED APPLICATION

This application claims the benefit of and priority to Japanese Application Number 2006-78568, filed Mar. 22, 2006, the contents of which are incorporated by reference herein in its entirety.

### BACKGROUND

1. Field

The present disclosure relates to creating authentication settings for a service that requires confidentiality in a service-oriented architecture.

2. General Background

With the wide use of the Internet, the number of systems handling electronic commerce or the like by using the Web has been increasing. These systems handle information, such as personal information, passwords and information on money, the confidentiality of which must be secured.

In addition, with the spread of the concept of a service-oriented architecture, services scattered around a network have been combined with one another, and thereby the services thus combined have been increasingly used as more advanced services.

Web Service Security (WS-Security) implemented with WebSphere Application Server (WebSphere is a registered trademark of International Business Machines Corporation in the United States, other countries, or both.) is available as a technology for these systems providing services handling electronic commerce and the like by using the Web. In WS-Security, definitions are given to methods such as adding a signature to a message, encrypting a message, and adding information used for authentication in order to protect Simple Object Access Protocol (SOAP) messages exchanged in the Web services. Moreover, Unified Modeling Language (UML) is often used for the purpose of developing these services.

However, in a case where an advanced service is developed by combining services scattered around the network, it is generally difficult to set securities, since the services often operate on different security platforms.

Furthermore, one cannot appropriately specify authentication settings, unless he/she sufficiently understands the difference in authentication mechanisms and security domains. In particular, service developers often have to set securities due to restrictions of the developing period, the budget and the like in actual projects, even though the security setting requires highly advanced technical knowledge, as is described above.

In addition, security policies required for a service need to be defined in order to set an authentication function in a service to be developed.

In the case of WS-Security, a high-level skill is required to correctly define security policies. In addition, appropriate policies cannot be created without correctly understanding functions provided by machine nodes which operate for a service to be developed. Although a service developer can define what kind of authentication functions are needed for the service, it is very difficult for the service developer to make detailed settings for securities depending on the machine nodes.

### SUMMARY

An information processing apparatus, a software development method and a computer program therefore, which allow a service developer, who develops a service requiring confidentiality in a service-oriented architecture, to easily create authentication settings for the service model is disclosed.

In one aspect, an information processing apparatus for developing a service requiring confidentiality in a service-oriented architecture is provided. The information processing apparatus includes: an input unit configured to receive as an input, an annotation for a service. A storage unit is configured to store an Authentication Infrastructure Model of a machine node on which the service is executed; and an Authentication Policy generation unit for generating an Authentication Policy by using the annotation and the Authentication Infrastructure Model.

In another aspect, a software development method and a computer program thereof is provided. The software development method is for developing a service requiring confidentiality in a service-oriented architecture, and includes inputting an annotation for a service; reading a stored Authentication Infrastructure Model of a machine node on which the service is executed; and generating an Authentication Policy by using the annotation and the Authentication Infrastructure Model.

### DRAWINGS

The above-mentioned features and objects of the present disclosure will become more apparent with reference to the following description taken in conjunction with the accompanying drawings wherein like reference numerals denote like elements and in which:

FIG. 1 is a conceptual diagram of one aspect of the present disclosure.

FIG. 2 is a diagram showing a structure of an information processing apparatus of the present disclosure.

FIG. 3 illustrates one aspect of the format of an Authentication Policy in accordance with the present disclosure.

FIG. 4 is a diagram of one aspect of an inner data structure of an Authentication Policy in accordance with the present disclosure.

FIG. 5 is a diagram of one aspect of a data structure of an Authentication Infrastructure Model of the example thereof.

FIG. 6 is a flow diagram illustrating a software development method in accordance with one aspect of the present disclosure.

FIG. 7 is a diagram showing one example of a service model, that is, a case of a travel agency.

FIG. 8 illustrates an example of the authentication used in the exemplary service model case of a travel agency.

FIG. 9 is a diagram showing an example of a graphical editor for entering an annotation for a service in accordance with one aspect of the present disclosure.

FIGS. 10 and 11 are flowcharts illustrating an example of Authentication Policy generation in accordance with the present disclosure.

FIG. 12 is a diagram showing a correspondence relationship between a service model and an Authentication Infrastructure Model of the example thereof.

FIG. 13 is a diagram showing a data structure of the travel agency of the example thereof.

FIG. 14 is a diagram showing a generated Authentication Policy used for a case where a customer accesses the travel agency of the example thereof.

FIG. 15 is a diagram showing a generated Authentication Policy used for a case where the travel agency sends a mileage number to an airline company in the example thereof.

FIG. 16 shows a hardware structure of an information processing apparatus in accordance with the present disclosure.

### DETAILED DESCRIPTION

Hereinafter, the present disclosure will be described by using embodiments of the present disclosure, but the present disclosure of the scope of claims is not limited to the following embodiments, and all combinations of features descried in the embodiments are not necessarily required for solving means of the present disclosure.

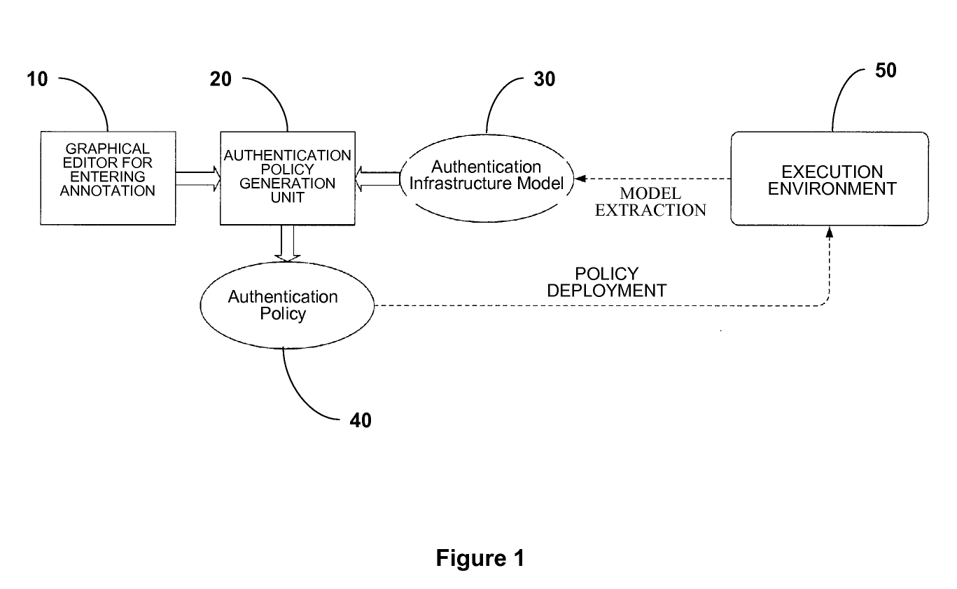

The idea and the structure of the present disclosure will be described by referring to FIGS. 1 to 6.

As shown in FIG. 1, a service developer can edit a service model by entering an annotation for a service through an input unit such as a graphical editor 10. The service model is made of a combination of the services, and allows an annotation indicating an authentication to be inputted for each of the services. An authentication policy generation unit 20 generates an Authentication Policy 40 by using the annotation on the authentication and an Authentication Infrastructure Model (AIM) 30. An Authentication Infrastructure Model is a model in which characteristic aspects related to authentication are modeled, and in the Model, information such as propagation of identification, a single sign on (SSO) and a trust relationship (Authentication Relationship) between services is represented. In one aspect, Authentication Policy 40 is a policy including necessary technical details such as the format of a user ID, authentication mechanisms and security domains.

The AIM 20 is based on an authentication infrastructure provided in an execution environment 50 where the service is executed, and is obtained by extracting a model from the execution environment as shown in FIG. 1. Note that, although the model extraction itself is an important issue, it is out of the range of the present disclosure. For this reason, it is represented by a dashed arrow. A generated Authentication Policy 40 is deployed in the execution environment 50. Here, since the deployment itself is a function normally provided in a commercial product, the description thereof is omitted.

By using an AIM 30, the present disclosure enables the generation of an Authentication Policy 40 corresponding to complicated authentication infrastructure with simple annotation expressions on a service model.

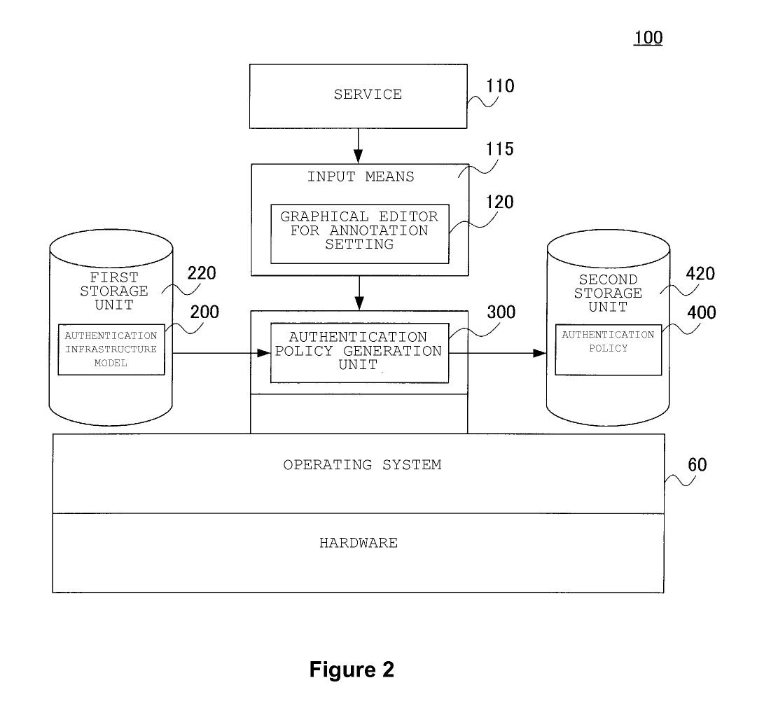

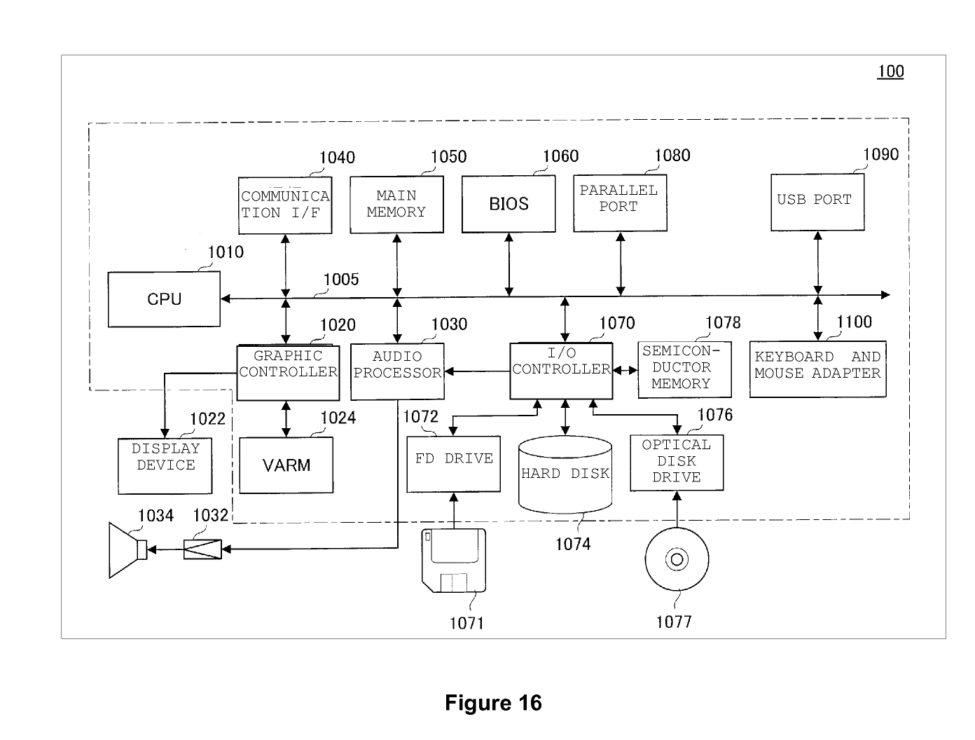

FIG. 2 is a view of one aspect of the structure of an information processing apparatus 100 of the present disclosure. The information processing apparatus 100 includes: an operating system 60 which operates on hardware shown in FIG. 16, described in detail later; input unit 115 for inputting an annotation for a service operating on the operating system 60; an graphical editor 120 for entering an annotation; an Authentication Infrastructure Model 200 of a machine node on which the service is executed; an Authentication Policy generation unit 300 for generating an Authentication Policy by using the annotation and the Authentication Infrastructure Model 200; a generated Authentication Policy 400; a first storage unit 220 in which the Authentication Infrastructure Model 200 is stored; and a second storage unit 420 in which the generated Authentication Policy 400 is stored. Note that, partitioned storage places in one storage unit can be respectively used for the first storage unit (220) and the second storage unit (420). The service 110 is a service requiring confidentiality in a service-oriented architecture, and can be developed as a service handling complicated authentication infrastructures by inputting an annotation in the input unit 115 of the information processing apparatus 100. In one aspect, inputting an annotation for a service is performed by entering an annotation using graphical editor 120.

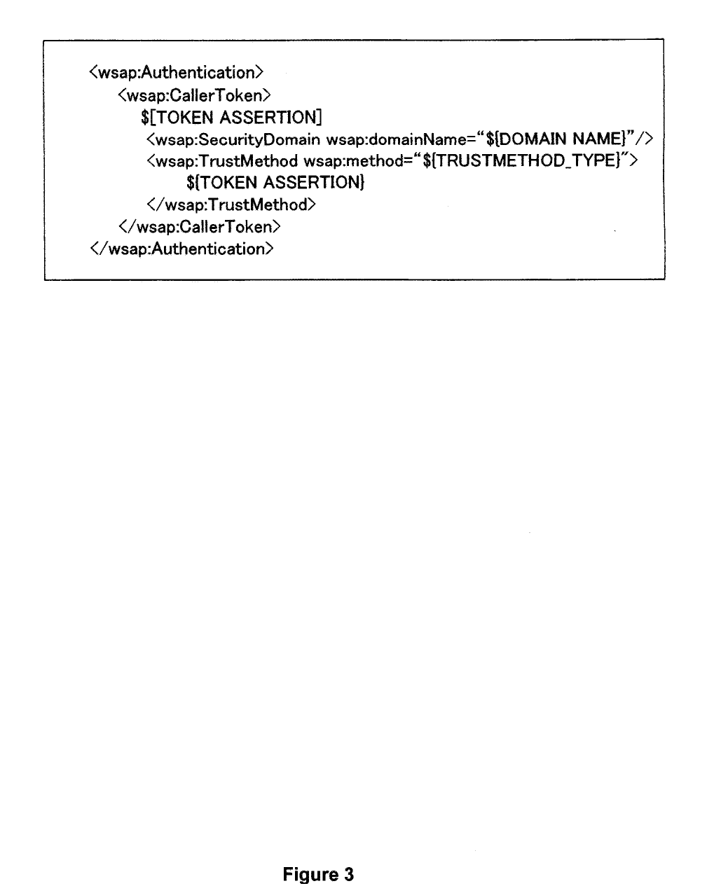

FIG. 3 illustrates one aspect of the format of an Authentication Policy in accordance with the present disclosure. The Authentication Policy in FIG. 3 is described according to WS-Security (refer to “Web Service Security”). This format is simply defined as the Authentication Policy within a program. Here, each of the elements will be described in the following.

The Authentication element in the first line is a top level element used for embedding authentication information in the Authentication Policy. The CallerToken element in the second line is a top level element used for entering specific information on an authentication. ${TOKEN ASSERTION} in the third line and the subsequent lines indicates a token in which information on ID is encoded. There are various kinds of tokens, and the kinds of tokens are described in this part. The descriptions defined in WS-SecurityPolicy standard { } are used for the actual contents of the tokens. In a case of a UsernameToken token, <UsernameToken> is just described.

SecurityDomain is used for a concept for discriminating between tokens. This is because only the description of a token kind, as described above, is not sufficient to discriminate the token. A domainName attribute is an element of SecurityDomain, and in the domainName attribute, the name of security domain is described.

In a case where a token does not contain information for authentication in ${TOKEN ASSERTION}, another method of establishing a trust relationship is needed. TrustMethod is an element of specifying a kind of method by using a method attribute. For example, an authentication is performed by using a digital signature in a case of Signature, or by using ID/password in a case of Basic.

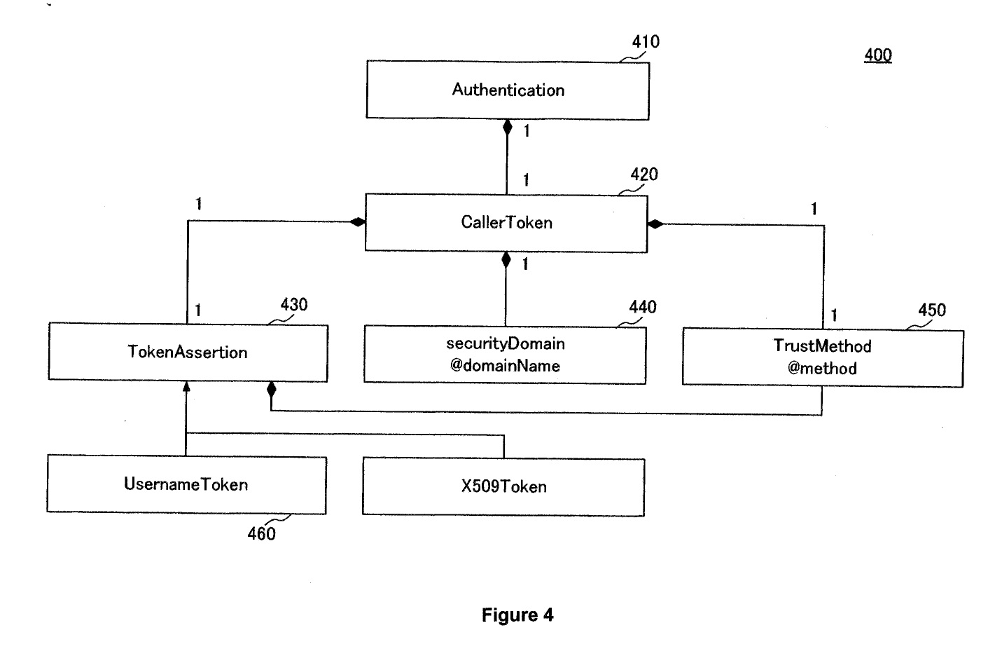

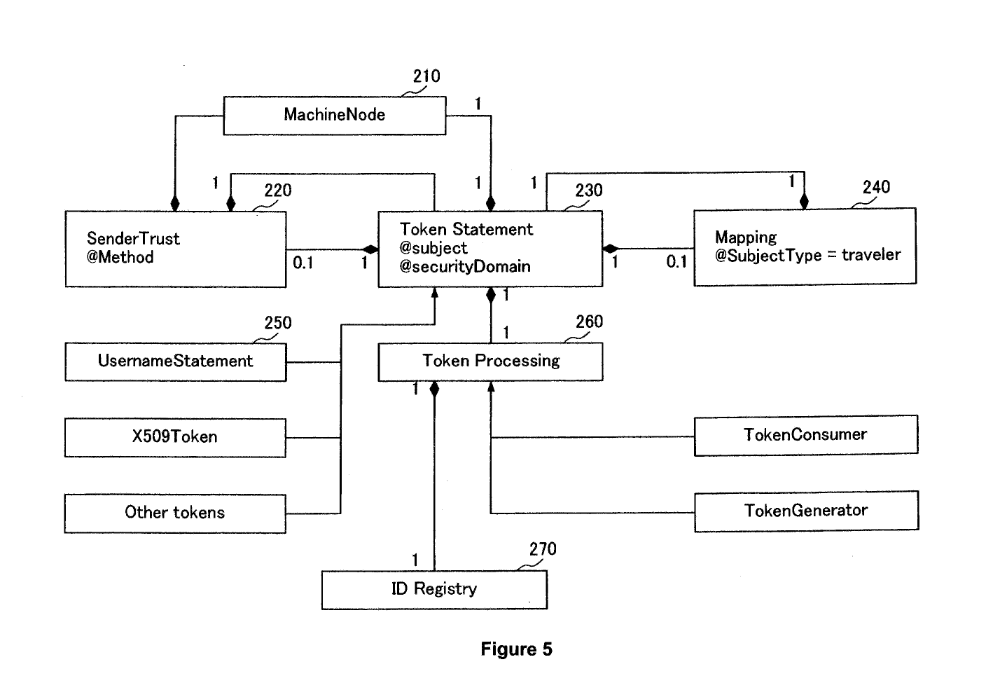

FIG. 4 is a diagram of one aspect of an inner data structure of an Authentication Policy in accordance with the present disclosure. Note that, FIGS. 4 and 5 are described in a manner as defined by the Unified Modeling Language (UML). For this reason, the inner structure in FIG. 4 almost corresponds to the structure of the above-described Authentication Policy, but there are additional points. A TokenAssertion 430 (token assertion) is defined as an abstract class, and a specific token is defined as its subclass. A TrustMethod 450 (a trust method) is linked to a TokenAssertion 430.

An authentication is generally used to establish a trust relationship. In this case, a token is required. In order to identify the kind of a token, the token is linked to the TokenAssertion. However, it should be noted that the TokenAssertion directly held by the CallerToken is different from the TokenAssertion indicated by the TrustMethod.

FIG. 5 illustrates one aspect of a data structure of the Authentication Infrastructure Model in accordance with the present disclosure. TokenStatement (a token assertion) 230 is an element for describing a statement of a token (i.e., encoded information on an ID, a password and the like, which are associated with an authentication). A kind of a target token and a method of processing the target token are expressed in other elements, and this TokenStatement element 230 itself has only two attributes that are a Subject attribute (a caller subject) and a securityDomain attribute. The Subject attribute has a truth-value showing whether a token is a primary token. The securityDomain attribute shows a security domain in which tokens are controlled.

SenderTrust (a sender trust method) 220 is an element for describing a method of establishing the foregoing trust relationship. This element is necessary only when the Subject attribute of the TokenStatement element 230 is true. Here, an authentication method is described in a method attribute, and Signature and Basic are examples of specific values of the method attribute to be entered. The value, Signature, indicates a method in which a sender is authenticated by using a digital signature. The value, Basic, indicates an authentication method using ID/Password. Although the SenderTrust element 220 has a TrustStatement element, this element is used for establishing a trust relationship (a secondary token). For this reason, a Subject attribute of the SenderTrust element 220 must be false.

MachineNode (a machine node) 210 is an element indicating a machine node in which an architecture is implemented. Since tokens that each node can receive and send are determined in advance, the node is linked to the TokenStatement element 230. In the same manner, a method of establishing a trust relationship is also information peculiar to the MachineNode element 210, the MachineNode element 210 is linked to the SenderTrust element 220. Although not sufficiently expressed in the drawing, the link between the MachineNode element 210 and any of the TokenStatement element 230 and the SenderTrust element 220 is set in a manner discriminating two kinds, that is, one for receiving and the other for sending, from each other.

TokenProcessing 260 (token processing) abstractly indicates information related to the implementation of token processing. In FIG. 5, the TokenProcessing 260 is connected to, as one example, a user registry and those belonging to an implementation class, such as TokenGenerator and TokenConsumer.

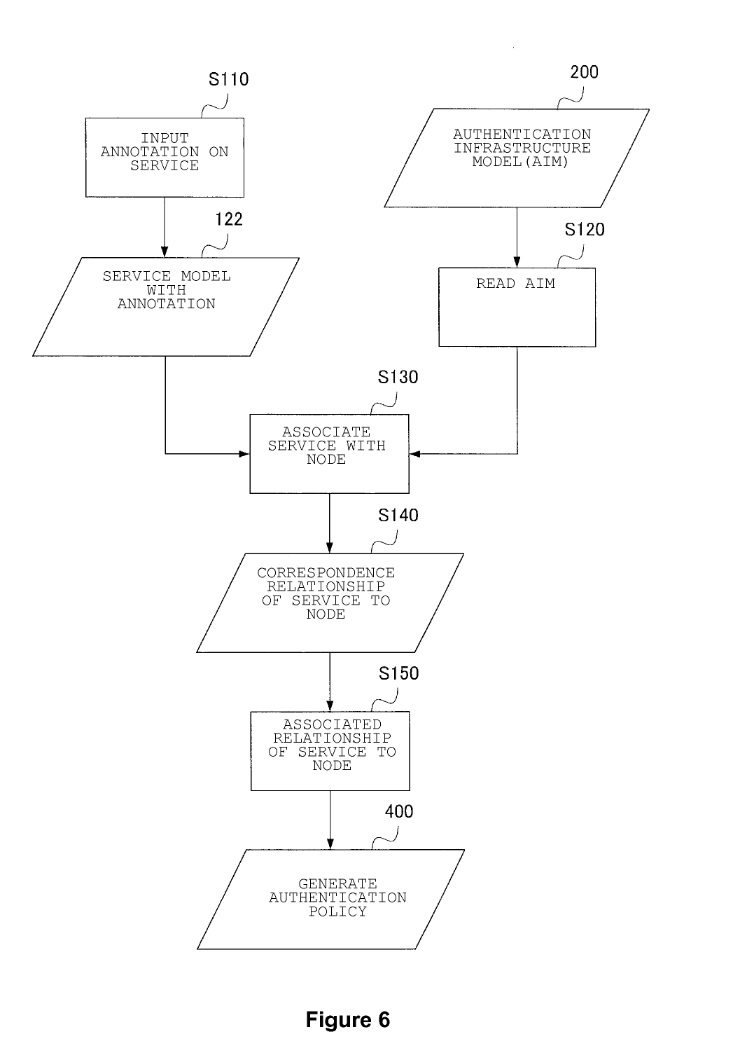

FIG. 6 is a flow diagram illustrating one aspect of an algorithm of a software development method of the present disclosure. As shown in FIG. 6, an annotation on a service is inputted from the input means 115 by using the graphical editor 120 for annotation setting (S110). Once inputted, a service model 112 with the annotation is generated. Then, AIM 200 stored in the first storage unit 220 is called (S120). The service and the machine node are associated with each other by using the service model 112 with the annotation and the AIM thus read (S130). On the basis of the association result, it is clarified how the service is associated with the node (S140), and an Authentication Policy is generated (S150). The generated Authentication Policy 400 is stored in the second storage unit 420. In a case where a service developer recognizes the necessity, the Authentication Policy is displayed on a display device 1022 to be described later.

In this way, an Authentication Policy corresponding to complicated Authentication Infrastructures can be generated from simple annotation expression on a service model.

The structure and the Authentication Policy of the present disclosure have been described hereinabove. For the sake of better understanding of the present disclosure, a specific example will be described below along with operations of the present disclosure.

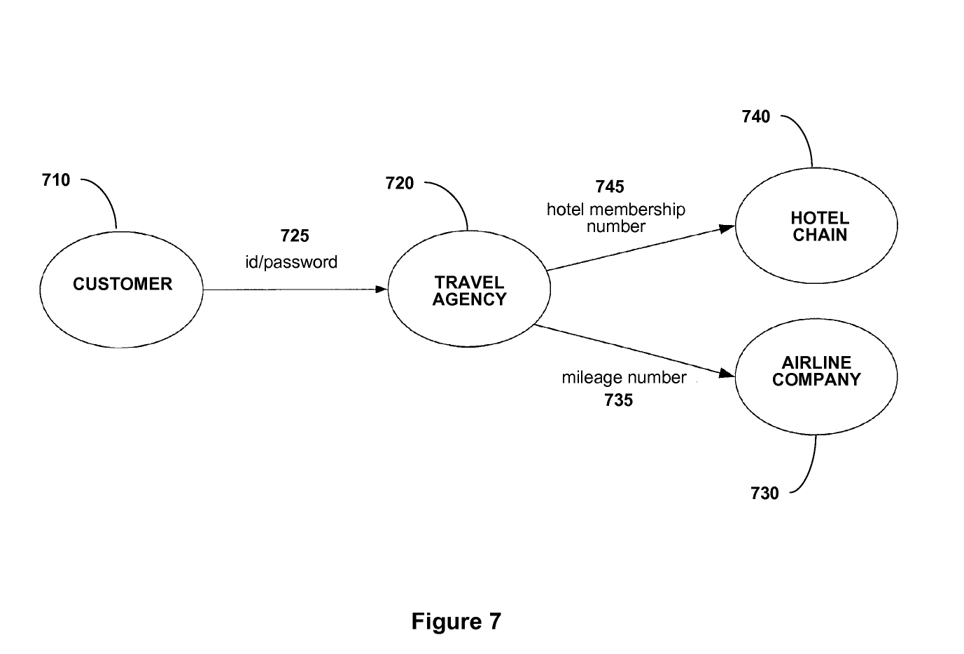

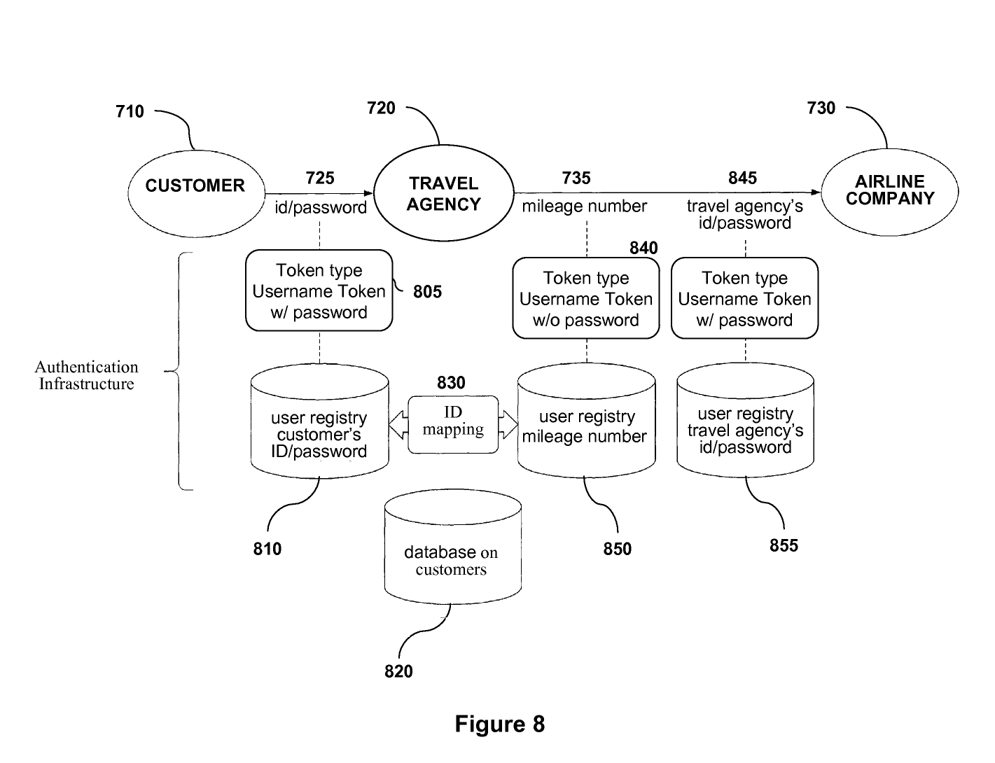

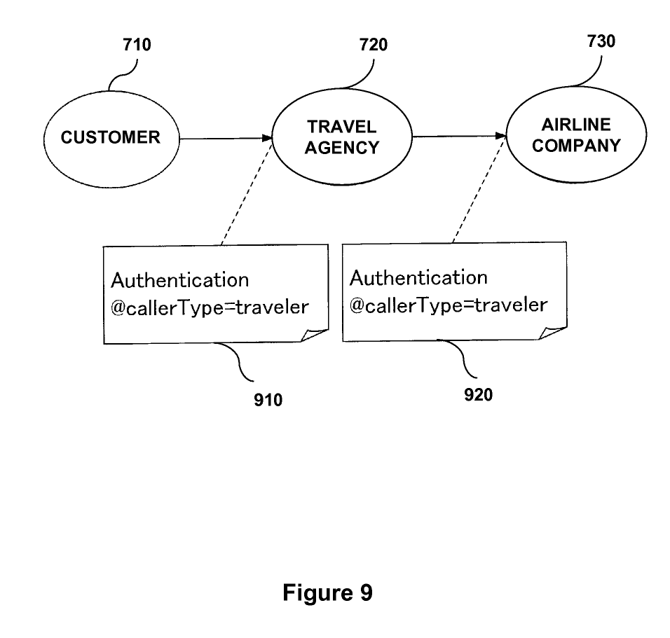

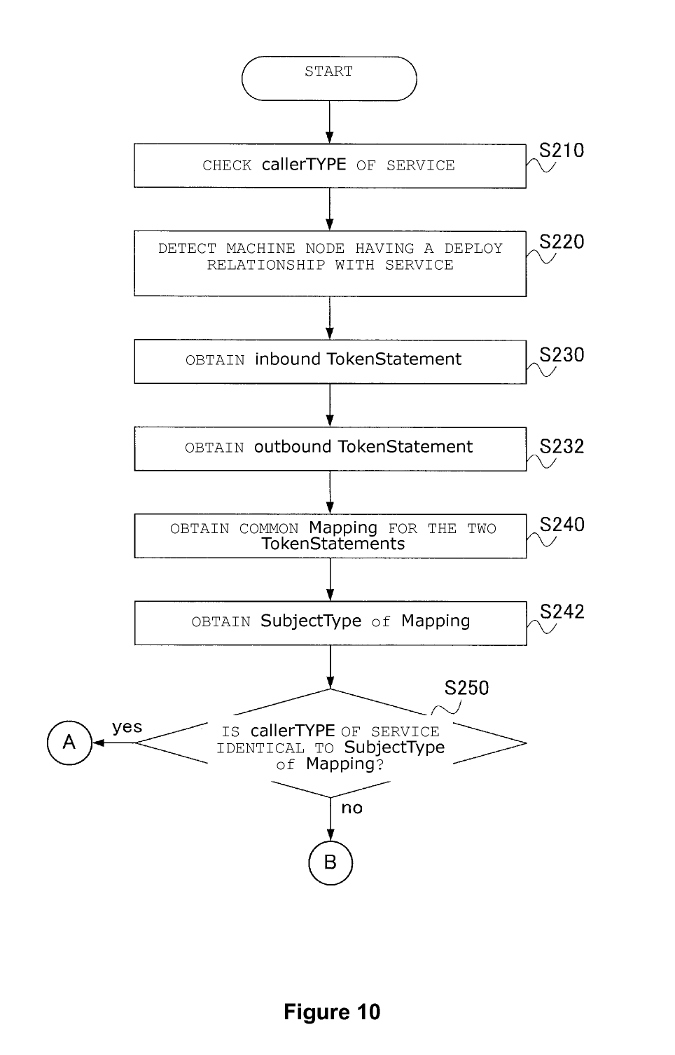

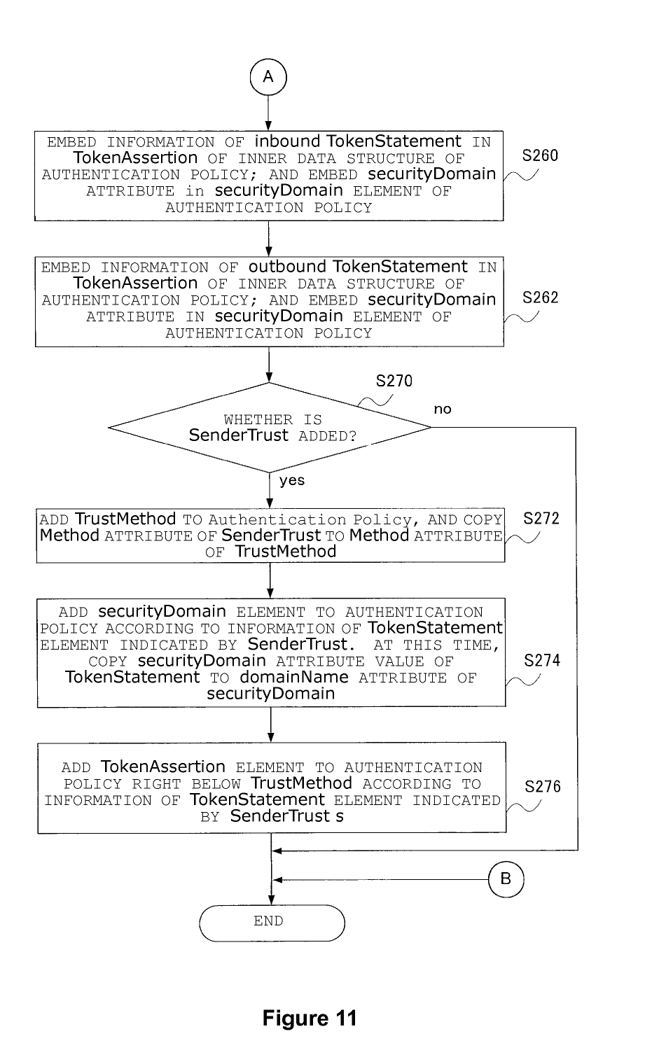

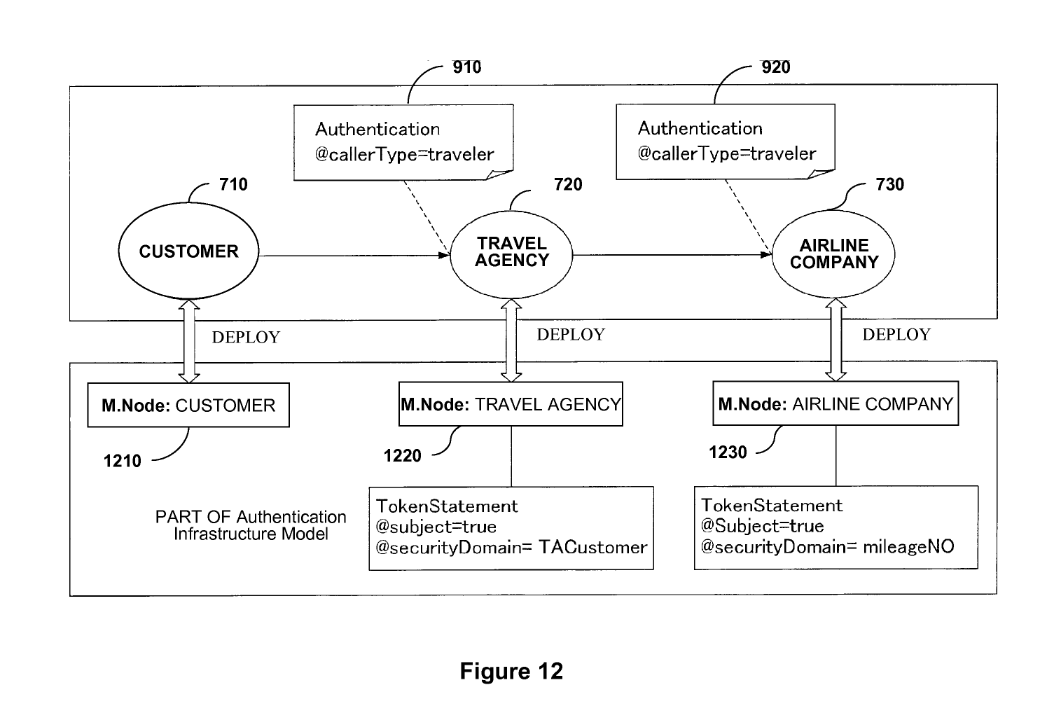

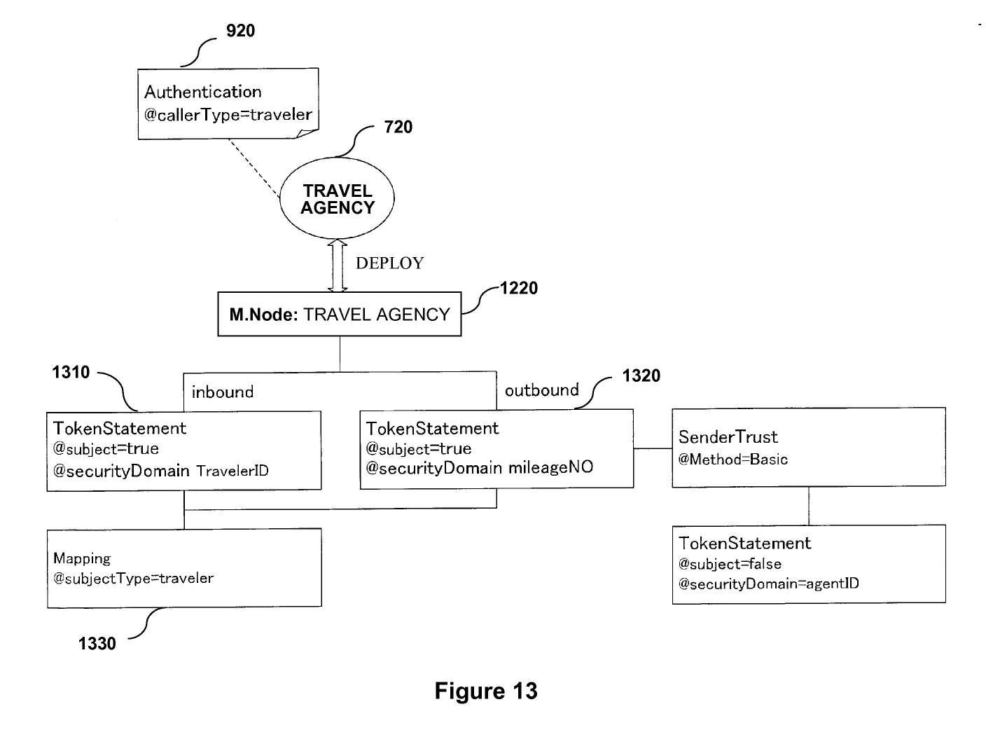

FIG. 7 is a diagram showing one example of a service model, that is, a case of a travel agency. FIG. 8 is a diagram showing a specific example of an authentication of the present disclosure. FIG. 9 is a diagram showing an example of the graphical editor for annotation setting of the present disclosure. FIGS. 10 and 11 are flowcharts of an Authentication Policy generation of the example of the present disclosure. FIG. 12 is a diagram showing a correspondence relationship between a service model and an AIM of the example of the present disclosure. FIG. 13 is a diagram showing a data structure of a travel agency of the example of the present disclosure. By referring to FIG. 7 to 13, the specific example will be described below.

FIG. 7 illustrates an example of a service model, that is, in the case of a travel agency. In this case, suppose that the following is carried out. When a customer plans a personal trip and makes a request of the personal trip to a travel agency, the travel agency collectively provides, to the customer, information on the availability and prices of an air ticket and an accommodation and the like, which is obtained by making inquiries to airline companies, hotel chains, and the like. When the customer 710 accesses the travel agency 720, he/she inputs his/her ID and password 725. The travel agency 720 manages information on each of the customers 710. When the travel agency 720 makes inquiries to the airline companies 730 and the hotel chains 740, a customer's number (a mileage number 735 and the like) is also sent thereto. Accordingly, information such as the customer's membership can be utilized so that, for example, a ticket having an advantage for the customer can be offered.

FIG. 8 illustrates an example of the authentication used in the exemplary service model case of a travel agency. As shown in FIG. 8, a customer 710 sends his/her ID/Password 725 to a travel agency 720. At this time, it is necessary to specify a method of encoding the ID/Password 725, and here the ID/Password are sent in the format of UsernameToken 805, as defined in WS-Security. That form is as follows:

<UsernameToken>
<Username>sfumiko</Username>
<Password>okimufs</Password>
</UsernameToken>

Once the travel agency 720 receives an ID/Password, a customer is authenticated on the basis of the ID/Password. Information for authenticating customer IDs are registered, and IDs and Passwords of customers are stored in a user registry 810.

Subsequently, the travel agency 720 needs to make an inquiry to an airline company 730. At the same time, a customer's mileage number 735 also needs to be sent to the airline company. Since the mileage number is required to correspond to the authenticated customer's ID, a correspondence process is referred to as ID mapping. IBM Tivoli Federated Identity Manager (a registered trademark) can be used for performing the ID mapping.

In the example shown here, information on mapping is stored in a database on customer information 820, and by using the database, ID mapping is performed. The travel agency sends a mileage number 735 in the following format (as indicated by UsernameToken 840) to an airline company 730.

<UsernameToken>
<Username>1234567</Username>
</UsernameToken>

In a case where a password is not included in the information sent from the travel agency, the airline company cannot authenticate the customer by using only this information. For this reason, the travel agency sends its own ID/Password 845 together with the mileage number 735. By using the ID/Password of the travel agency, the airline company authenticates the travel agency. Thereafter, the airline company 730 trusts the received information, because the mileage number is sent from the authenticated travel agency 720. Note that the airline company 730 confirms the mileage number 735 and the ID/Password 845 of the travel agency, which have been sent, respectively by using corresponding user registries 850 and 855. Here, the user registry indicates a file in which user's data is registered.

FIG. 9 is a diagram showing an example of a graphical editor for entering an annotation for a service in accordance with one aspect of the present disclosure. A service developer, who is a user of the information processing apparatus of the present disclosure, adds annotations 910 and 920 on a screen as shown in FIG. 9. In the case of authentication, the service developer may add an Authentication element, and set a value in a callerType attribute in the Authentication element.

As shown in FIG. 9, an identical attribute value, traveler, is used for values of two callerType attributes: one from a customer 710 to a travel agency 720, and the other from the travel agency 720 to an airline company 730. The service developer neither can understand the details of an authentication infrastructure shown in FIG. 8 in many cases, nor wants to bother with the details. In the example of the travel agency, IDs gives an impression as if there were plural different customers. However, the plural customers who seem as if they are different from one another with respect to the IDs are actually a single customer. By specifying the customers simply as a traveler without discriminating these IDs, therefore, a service developer may regard them as the single customer conceptually. This point that an annotation for such an authentication is introduced is one of the features of the present disclosure.

FIGS. 10 and 11 are flowcharts illustrating an example of Authentication Policy generation in accordance with the present disclosure. The Authentication Policy generation is carried out as follows. In a case where an annotation that sets a value in the callerType attribute is added as is described above, the callerType attribute of a service is checked (S210). In the example of FIG. 9, since the callerType attribute value is traveler, a check may be made only about traveler. Next, machine nodes which have a deploy relationship with the service are detected (S220). The reason for referring to the relationship as a deploy relationship is that a service is deployed on machine nodes (specific apparatuses, personal computers, workstations and the like). The detected result is a state shown in FIG. 12, in which a customer 710, a travel agency 720 and an airline company 730 are detected as machine nodes 1210, 1220, and 1230, respectively. Each node is prepared for an AIM in advance. For example, the travel agency has a data structure shown in FIG. 13. The structure shown in FIG. 13 is a specific example of the travel agency corresponding to the contents shown in FIG. 5.

As for each of the detected machine nodes, information on an inbound TokenStatement element (a token assertion) is obtained from the AIM stored in a storage unit (S230). Here, inbound indicates a token assertion that comes into a machine node. In a case of the example of FIG. 13, inbound is a token assertion 1310 that comes into a machine node (a server and the like) of the travel agency. Next, as for each of the detected machine nodes, information on an outbound TokenStatement element is obtained from the AIM stored in the storage unit (S232). Here, outbound indicates a token assertion that goes out of a machine node. According to the example of FIG. 13, outbound is a token assertion 1320 that goes out of the machine node of the travel agency.

Then, a common Mapping between these is obtained (S240). Here, Mapping indicates an element that defines a correspondence relationship between security domains. The Mapping element 1330 gives a definition of a relationship associating a plurality of TokenStatement elements with one another, whereby the security domains of the TokenStatement elements are associated with one another. In the example of the travel agency of FIG. 13, a customer's ID/Password and a customer's mileage number are associated with each other. The Mapping element 1330 is used for establishing such a correspondence relationship. In this element, a subjectType attribute is defined. When a plurality of TokenStatement elements are associated with one another via a Mapping element 1330, the TokenStatement elements can be regarded as those indicating the same user type. Accordingly, a name is specified by using the subjectType attribute of the Mapping element 1330.

Subsequently, a subjectType value of the Mapping element 1330 is obtained (S242). In the example of the travel agency, a common Mapping element 1330 of the inbound TokenStatement element 1310 (the token assertion) and the outbound TokenStatement element 1320 has a value, traveler, as shown in FIG. 13, and therefore the traveler is obtained.

Once obtained, it is verified whether the callerType attribute value of the service and the SubjectType attribute value of the Mapping element 1330 are identical (S250). In a case where they are identical, the content of the AIM stored in the storage unit is embedded in an Authentication Policy (A). In a case where they are not identical, the content is not embedded, and the process is terminated (B).

In a case where they are identical, the information of the inbound TokenStatement 1310 is embedded in a portion of the TokenAssertion of the inner data structure of the Authentication Policy, and the securityDomain attribute is embedded in the SecurityDomain element of the Authentication Policy (S260).

In the same way, the information of the outbound TokenStatement element 1320 is embedded in a portion of the TokenAssertion of an inner data structure of the Authentication Policy, and the securityDomain attribute is embedded in the SecurityDomain element of the Authentication Policy (S262).

Next, it is investigated whether a SenderTrust element is included in the contents of the AIM stored in the storage unit (S270). In a case where the SenderTrust element is included, its contents are incorporated into the Authentication Policy. In a case where the SenderTrust element is not included, the processing is terminated.

In the case where the SenderTrust element is included, a TrustMethod element is added to the Authentication Policy, and a value of the Method attribute of the SenderTrust element is copied to a Method attribute of the TrustMethod element (S272).

In addition, on the basis of the information of the TokenStatement element indicated by the SenderTrust element, a securityDomain element is added to the Authentication Policy. At this time, a value of the securityDomain attribute of the TokenStatement element is copied to the domainName attribute of the securityDomain element (S274).

Furthermore, on the basis of the information of the TokenStatement element indicated by the SenderTrust element, a TokenAssertion element is added to the Authentication Policy right below the TrustMethod element (S276).

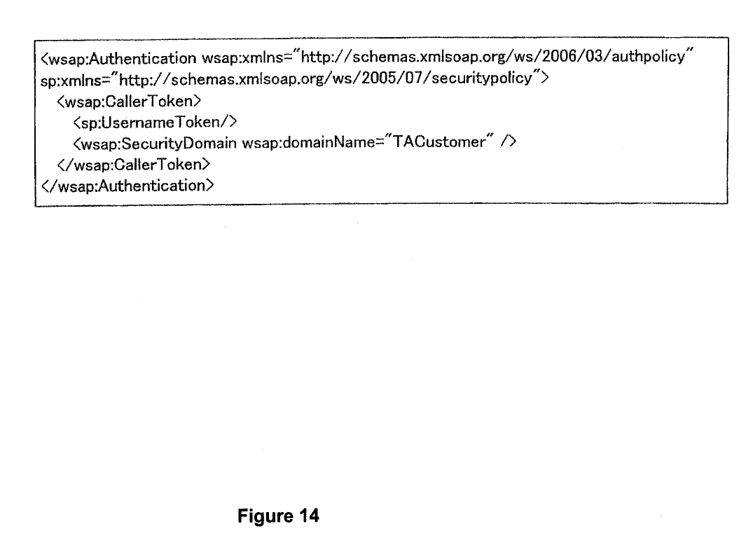

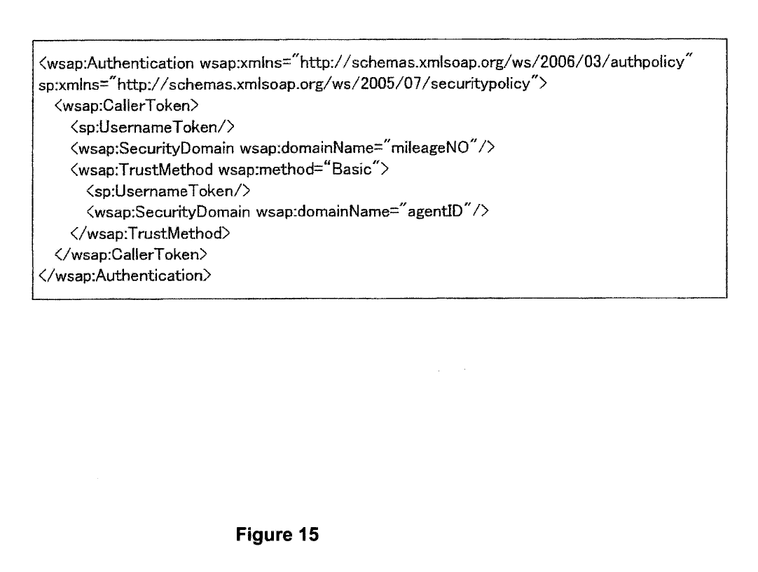

In this way, an Authentication Policy can be generated. Examples of the Authentication Policy thus generated are shown in FIGS. 14 and 15. FIG. 14 shows a generated Authentication Policy used for a case where a customer accesses a travel agency in the example described thus far. Here, the customer is authenticated by using an ID/Password of a TACustomer domain in the 5th line in FIG. 14 (here, no trust is required).

FIG. 15 shows a generated Authentication Policy used for a case where the travel agency sends the mileage number to the airline company, and accesses thereto in the example of the present disclosure. Here, since only the mileage number is sent, a trust method (TrustMethod) is additionally required. In this case, an ID of a security domain of a travel agency's ID (agentID) is required. Moreover, the authentication method is specified as Basic, and this means that an authentication is performed by using an ID/Password. In general, an authentication using an ID/Password is referred to as Basic Authentication. In addition, a SecurityDomain element is put right below a TrustMethod element.

The generated Authentication Policy 400 is stored in the second storage unit 420. If necessary, a service developer can check the contents stored in the second storage unit 420 by displaying the contents on a display device 1022 to be described later, although he/she in general does not need to view the contents.

FIG. 16 is a diagram showing an example of a hardware structure of the information processing apparatus 100. The information processing apparatus 100 includes a central processing unit (CPU) 1010, a bus line 1005, a communication I/F 1040, a main memory 1050, a basic input output system (BIOS) 1060, a parallel port 1080, a USB port 1090, a graphic controller 1020, a VARM 1024, an audio processor 1030, an I/O controller 1070, and input means 115 such as adapters 1100 for a keyboard, a mouse and the like. Storage means can be connected to the I/O controller 1070, and the storage means include a flexible disk (FD) drive 1072, a hard disk 1074, an optical disk drive 1076, a semiconductor memory 1078 and the like. These storage means can be used as the first storage unit 220 and the second storage unit 420.

An amplifier circuit 1032 and a speaker 1034 are connected to the audio processor 1030. In addition, a display device 1022 is connected to the graphic controller 1020.

The BIOS 1060 stores a boot program that the CPU executes at the time of starting the information processing apparatus 100, a program being dependent on the hardware of the information processing apparatus 100, and the like. The flexible disk drive 1072 reads a program or data from a flexible disk 1071, and provides the read-out program or data to the main memory 1050 or the hard disk 1074 through the I/O controller 1070.

As the optical disk drive 1076, for example, a DVD-ROM drive, a CD-ROM drive, a DVD-RAM drive and a CD-RAM drive can be used. When using the optical disk drive 1076, an optical disk 1077 corresponding to each of the drives needs to be used. A program or data is read from the optical disk 1077 with the optical disk drive 1076, so that the program or data can be provided to the main memory 1050 or the hard disk 1074 through the I/O controller 1070.

A computer program provided to the information processing apparatus 100 is stored in advance in a recording medium such as the flexible disk 1071, the optical disk 1077, a memory card or the like, and is provided by a user. The computer program is read from the recording medium through the I/O controller 1070 or is downloaded through the communication I/F 1040, whereby the computer program is installed in the information processing apparatus 100, thereby being executed. Operations, which the computer program causes an information processing apparatus to execute, are the same as those in the information processing apparatus 100 described in FIGS. 1 to 15, and a description thereof is omitted here.

The computer program describe above may also be stored in an external storage medium. As the external storage medium, a magneto-optical recording medium such as a MD, or a tape medium can be used other than the flexible disk 1071, the optical disk 1077, or a memory card. Moreover, it is also possible to use, as a recording medium, a storage device such as a hard disk or an optical desk library provided to a server system, which is connected to a dedicated communication line or the Internet, and thereby to provide the computer program to the information processing apparatus 100 through the communication line.

Although the foregoing descriptions have been given mainly of the examples of the information processing apparatus, the same functions as those of the above-described information processing apparatus can be achieved in the following manner.

A program having the functions described using the information processing apparatus is installed in a computer, and then causes the computer to operate as the information processing apparatus. Accordingly, the information processing apparatus described as one embodiment of the present disclosure can be achieved by using a software development method and a developed computer program.

Although the present disclosure has been described by using the embodiment and the examples hereinabove, the present disclosure is not limited to the descriptions of the above embodiment. Various changes or modifications can be made in the above-described embodiment. In addition, it is clear from the scope of claims that such changes or modifications are also included in the technical scope of the present disclosure.

Although the preferred embodiment of the present disclosure has been described in detail, it should be understood that various changes, substitutions and alternations can be made therein without departing from spirit of the disclosures as defined by the appended claims.

1. An apparatus comprising:
an input unit configured to receive as an input an annotation for a service;
a storage unit configured to store an Authentication Infrastructure Model of a machine node on which the service is executed; and
an Authentication Policy generation unit configured to generate an Authentication Policy by using the annotation and the Authentication Infrastructure Model.

2. The apparatus according to claim 1, wherein the input unit adds an annotation to the modeled service on a graphical editor.

3. The apparatus according to claim 2, wherein the annotation indicates an authentication assertion and a caller type.

4. The apparatus according to claim 1, wherein the Authentication Infrastructure Model includes a collaboration between a plurality of services, a propagation of identification, a single sign on, and a trust relationship between services.

5. The apparatus according to claim 1, wherein the Authentication Policy specifies a format of user identification, an authentication mechanism, a security domain, and trust confirmation means.

6. The apparatus according to claim 5, wherein:
the Authentication Policy generation unit detects a caller type from the annotation for the service, and a machine node which has a deploy relationship with the service from the storage unit;
the Authentication Policy generation unit obtains a common mapping of a token assertion from an Authentication Infrastructure Model of the detected machine node, and a caller subject from the mapping;
in a case where the caller type and the caller subject are identical, the Authentication Policy generation unit sets: information and a security domain attribute of a token assertion on a receiving side of the machine node, in a receiving side of the Authentication Policy, and information and a security domain attribute of a token assertion on a sending side of the machine node, in a sending side of the Authentication Policy; and
in a case where a sender trust method element is attached to the token assertion, the Authentication Policy generation unit sets the trust confirmation means in the Authentication Policy.

7. A method comprising:
inputting an annotation for a service, the service requiring confidentiality in a service-oriented architecture;
reading a stored Authentication Infrastructure Model of a machine node on which the service is executed; and
generating an Authentication Policy by using the annotation and the Authentication Infrastructure Model.

8. The method according to claim 7, wherein the inputting comprises adding an annotation for the service using a graphical editor.

9. The method according to claim 8, wherein the annotation indicates an authentication assertion and a caller type.

10. The method according to claim 7, wherein the Authentication Infrastructure Model includes a collaboration between a plurality of services, a propagation of identification, a single sign on, and a trust relationship between services.

11. The method according to claim 7, wherein the Authentication Policy specifies a format of user identification, an authentication mechanism, a security domain, and a trust confirmation.

12. The method according to claim 11, wherein generating the Authentication Policy further comprises:
detecting a caller type from the annotation for the service;
detecting a machine node which has a deploy relationship with the service;
obtaining a common mapping of a token assertion from an Authentication Infrastructure Model of the detected machine node;
obtaining a caller subject from the mapping;
setting a security domain attribute of a receiving side of the Authentication Policy to a security domain attribute of the token assertion on a receiving side of the machine node, and setting a security domain attribute of the Authentication policy to a security domain attribute of the token assertion on a sending side, in a case where the caller type and the caller subject are identical; and
setting the trust confirmation in the Authentication Policy, in a case where a sender trust method element is attached to the token assertion.

13. A computer program product comprising a computer useable medium having a computer readable program, wherein the computer readable program when executed on a computer causes the computer to:
receive as an input, an annotation for a service, the service requiring confidentiality in a service-oriented architecture;
read a stored Authentication Infrastructure Model of a machine node on which the service is executed; and
generate an Authentication Policy by using the annotation and the Authentication Infrastructure Model.

14. The computer program product according to claim 14, wherein the annotation for the service is inputted using a graphical editor.

15. The computer program product according to claim 14, wherein the annotation indicates an authentication assertion and a caller type.

16. The computer program product according to claim 14, wherein the Authentication Infrastructure Model includes a collaboration between a plurality of services, a propagation of identification, a single sign on, and a trust relationship between services.

17. The computer program product according to claim 14, wherein the Authentication Policy specifies a format of user identification, an authentication mechanism, a security domain, and a trust confirmation.

18. The computer program product according to claim 17, wherein generating the Authentication Policy further comprises:
detecting a caller type from the annotation for the service;
detecting a machine node which has a deploy relationship with the service;
obtaining an inbound token statement, the inbound token statement being a token statement received by the detected machine node;
obtaining an outbound token statement, the outbound token statement being a token statement being sent by the detected machine node;
obtaining a common mapping for the inbound token statement and the outbound token statement from an Authentication Infrastructure Model of the detected machine node;
obtaining a caller subject from the mapping; and
embedding a security domain attribute of the inbound token statement in a receiving side of the Authentication Policy, and embedding a security domain attribute of the outbound token statement in a sending side of the Authentication Policy, in a case where the caller type and the caller subject are identical.

19. The computer program product according to claim 18 further comprising adding a trust confirmation to the Authentication Policy, in a case where a sender trust method element is attached to the token statement.

20. The computer program product according to claim 19 wherein adding a trust confirmation to the Authentication Policy comprises copying a value of the sender trust method element to a trust method element of the Authentication Policy.
